(19) United States
(12) Patent Application Publication
(10) Pub. No.: US 2026/0095645 A1
(43) Pub. Date: Apr. 2, 2026

(54) INFORMATION PROCESSING APPARATUS, INFORMATION PROCESSING METHOD, INFORMATION PROCESSING PROGRAM, AND IMAGING APPARATUS

(71) Applicant: FUJIFILM Corporation, Tokyo (JP)

(72) Inventor: Toshiaki NAGAI, Saitama-shi (JP)

(73) Assignee: FUJIFILM Corporation, Tokyo (JP)

(21) Appl. No.: 19/344,382

(22) Filed: Sep. 29, 2025

(30) Foreign Application Priority Data
Sep. 30, 2024 (JP) 2024-170386

(51) Int. Cl. H04N 23/63

(52) U.S. Cl. CPC H04N 23/633; H04N 23/631

(57) ABSTRACT

An information processing apparatus generates list image data in which thumbnail images of image data included in an imaging data group imaged in a film camera mode are listed. The list image data is set in a template based on a maximum number of a captured image count in the film camera mode. The thumbnail images are disposed in the template in an imaging order.

### CROSS-REFERENCE TO RELATED APPLICATIONS

This application claims priority under 35 U.S.C §119(a) to Japanese Patent Application No. 2024-170386 filed on 30 September 2024. The above applications are hereby expressly incorporated by reference, in its entirety, into the present application.

### BACKGROUND OF THE INVENTION

### 1. Field of the Invention

The present disclosure relates to an information processing apparatus, an information processing method, a non-transitory computer readable medium for storing an information processing program, and an imaging apparatus.

### 2. Description of the Related Art

JP2006-74592A (corresponding to US2006/0053370A1) discloses that, in a case where image data is disposed in a layout, a position of the image data in the layout is designated in accordance with the number of the image data assigned to a predetermined page, and the image data is disposed in accordance with the designated position.

JP2020-75360A (corresponding to US2020/0145544A1) discloses that an image list is generated and displayed in which a blank image is disposed in a field of a file in which thumbnail images are not included, and read thumbnail images are disposed in a field of a file in which the thumbnail images are included.

JP1998-200839A (JP-H10-200839A) discloses that, in a case where a cursor is stopped, an imaging condition of a selected image candidate at a position where the cursor is stopped, or the like is displayed.

JP2019-117318A discloses that a size, the number of pages, a layout, a background, and the like of a photo book can be selected, layout selection can designate the number of images to be disposed per page, an allocation position of the image, and the like, and background selection can designate a color, a pattern, and the like of the background.

### SUMMARY OF THE INVENTION

An object of an exemplary embodiment of the invention is to provide an information processing apparatus, an information processing method, a non-transitory computer readable medium for storing an information processing program, and an imaging apparatus that can generate list image data with a sense of unity regardless of a captured image count of image data included in an imaging data group in a case of listing thumbnail images of the image data.

An information processing apparatus according to an aspect of the exemplary embodiment comprises a processor, in which the processor is configured to: acquire an imaging data group imaged in a first imaging mode in which a captured image count is restricted; and generate list image data in which thumbnail images of image data included in the imaging data group are listed, the list image data is set in a template based on a number related to the restriction of the captured image count, and the thumbnail images are disposed in the template in an order based on information related to the image data.

It is preferable that the number of the thumbnail images that are disposable in the template is determined based on the number related to the restriction of the captured image count, and the thumbnail images disposed in the template are disposed to be packed from an end part in the order based on the information related to the image data.

It is preferable that the template includes a plurality of frames in which the thumbnail images are disposed in a first direction, and each of the frames is disposed in a second direction. It is preferable that the thumbnail images are disposed to be packed from one end in the frame in the order based on the information related to the image data.

It is preferable that the frames include a first frame in which the thumbnail images are disposed in accordance with a first number and a second frame in which the thumbnail images are disposed in accordance with a second number smaller than the first number, and the template is composed of the first frame disposed in accordance with a third number in the second direction and the second frame disposed at one end in the second direction.

It is preferable that the first frame and the second frame differ in shape. It is preferable that the thumbnail images are disposed to be packed from one end in the first frame and/or the second frame in the order based on the information related to the image data.

It is preferable that, in a case where a number of thumbnail images less than the number related to the restriction of the captured image count are disposed in the template, the thumbnail images are disposed to be packed from one end in the first frame or the second frame in the order based on the information related to the image data, and a portion other than a portion in which the thumbnail images are disposed in the first frame or the second frame is made blank.

It is preferable that, in a case where at least one item in the image data is deleted, the processor makes a portion of the list image data where the deleted image data has been disposed blank. It is preferable that, in a case where at least one item in the image data loses relevance to the imaging in the first imaging mode, the processor makes a portion of the list image data where the image data that has lost the relevance is disposed blank.

It is preferable that the processor is configured to superimpose an imaging condition set in the first imaging mode on the list image data. It is preferable that the imaging condition is data associated with a management file included in the imaging data group. It is preferable that the processor is configured to superimpose the imaging condition on each of the thumbnail images.

It is preferable that the list image data consists of a first layer which is a layer of background data, a second layer which is a layer of data related to the imaging condition, and a third layer which is a layer of the image data.

It is preferable that in the first imaging mode, in addition to the restriction of the captured image count, at least two of restriction of image formats, restriction of output of a live view, restriction of storage of a series of image data obtained by the imaging in the first imaging mode in a format other than a single unit format, and restriction of a second imaging operation following a first imaging operation are performed.

It is preferable that the number related to the restriction of the captured image count is a maximum number of the captured image count. It is preferable that the order based on the information related to the image data is an imaging order.

An imaging apparatus according to an aspect of the exemplary embodiment is used as the information processing apparatus.

An information processing method according to an aspect of the exemplary embodiment, comprising: via a processor of an information processing apparatus, acquiring an imaging data group imaged in a first imaging mode in which a captured image count is restricted; and generating list image data in which thumbnail images of image data included in the imaging data group are listed, in which the list image data is set in a template based on a number related to the restriction of the captured image count, and the thumbnail images are disposed in the template in an order based on information related to the image data.

A non-transitory computer readable medium according to an aspect of the exemplary embodiment stores an information processing program that causes a processor of an information processing apparatus to execute a function of acquiring an imaging data group imaged in a first imaging mode in which a captured image count is restricted, and a function of generating list image data in which thumbnail images of image data included in the imaging data group are listed, in which the list image data is set in a template based on a number related to the restriction of the captured image count, and the thumbnail images are disposed in the template in an order based on information related to the image data.

According to the exemplary embodiments of the invention, it is possible to generate the list image data with the sense of unity regardless of the captured image count of the image data included in the imaging data group in a case of listing the thumbnail images of the image data.

### BRIEF DESCRIPTION OF THE DRAWINGS

FIG. 1 is a front perspective view of an imaging apparatus.

FIG. 2 is a rear perspective view of the imaging apparatus.

(A) of FIG. 3 is a descriptive diagram illustrating a position of a lever in a case where the imaging apparatus is powered off, (B) of FIG. 3 is a descriptive diagram illustrating a normal position of the lever in a case where the imaging apparatus is powered on, and (C) of FIG. 3 is a descriptive diagram illustrating a maximum rotational position of the lever during a winding operation.

FIG. 4 is a block diagram illustrating a schematic configuration of the imaging apparatus.

(A) of FIG. 5 is an image diagram of a display displaying a screen of a normal mode, and (B) of FIG. 5 is a diagram of an image of the display displaying a screen of a film camera mode.

FIG. 6 is an image diagram of the display displaying a detailed screen of the film camera mode.

(A) of FIG. 7 is a descriptive diagram illustrating a screen of a touch operation disabled region immediately after the film camera mode is started, (B) of FIG. 7 is a descriptive diagram illustrating a screen of the touch operation disabled region during the winding operation, and (C) of FIG. 7 is a descriptive diagram illustrating a screen of the touch operation disabled region after an imaging operation is completed.

FIG. 8 is a rear view of the imaging apparatus in a case where the imaging operation is performed while a lock is set on the imaging operation.

FIG. 9 is an image diagram of the display in a case where the imaging operation is performed while the lock is set on the imaging operation.

(A) of FIG. 10 is an image diagram of the display displaying a screen during the film camera mode, (B) of FIG. 10 is an image diagram of the display displaying a film camera mode finish selection screen, and (C) of FIG. 10 is an image diagram of the display displaying a normal screen.

(A) of FIG. 11 is an image diagram of the display displaying a screen during the film camera mode, (B) of FIG. 11 is an image diagram of the display displaying a film camera mode finish screen, and (C) of FIG. 11 is an image diagram of the display displaying the normal screen.

FIG. 12 is a descriptive diagram illustrating a thumbnail image diagram.

FIG. 13 is a table showing modes 1 to 10 of the film camera mode.

FIG. 14 is a descriptive diagram illustrating an information processing apparatus that communicates with the imaging apparatus.

FIG. 15 is a front view of the information processing apparatus that displays a template in which 72 thumbnail images are disposed.

FIG. 16 is a schematic diagram of the template.

FIG. 17 is a front view of the information processing apparatus that displays a template in which 54 thumbnail images are disposed.

FIG. 18 is a front view of the information processing apparatus that displays a template in which 36 thumbnail images are disposed.

FIG. 19 is a front view of the information processing apparatus that displays a template in a case where the image data is deleted.

FIGS. 20A to 20E are descriptive diagrams illustrating a part of a template on which imaging conditions are superimposed and displayed.

FIG. 21A is a descriptive diagram illustrating a first layer, FIG. 21B is a descriptive diagram illustrating a second layer, and FIG. 21C is a descriptive diagram illustrating a third layer.

FIG. 22 is a rear view of the imaging apparatus that displays a template.

FIG. 23 is a flowchart illustrating a series of flows of an information processing method.

### DESCRIPTION OF THE PREFERRED EMBODIMENTS

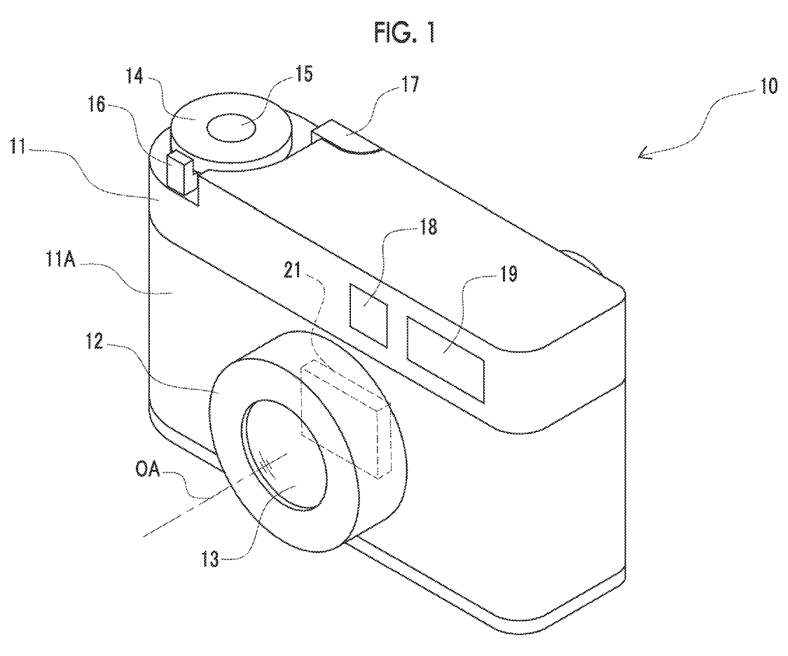

As illustrated in FIG. 1, an imaging apparatus 10 comprises a camera body 11 and a lens barrel 12. The camera body 11 has a horizontally elongated box shape of which a dimension in a left-to-right direction is larger than a dimension in an up-to-down direction in a front view. The imaging apparatus 10 is preferably a digital camera or the like.

The camera body 11 is provided with a grip 11A in its end part on a left side in the front view. The grip 11A has a semi-cylindrical shape connecting a front surface and a rear surface of the camera body 11 and has a shape easily held by a user. The lens barrel 12 is disposed on the front surface of the camera body 11 and is provided with an imaging optical system 13. The imaging optical system 13 forms an image of subject light on an imaging element 21 provided on an optical axis OA.

A mode dial 14, a release switch 15, a power switch 16, a lever 17, and the like are provided on an upper surface of the camera body 11. The mode dial 14 is used for switching an exposure level and the like in a stepwise manner. Not only the lens barrel 12 but also a flash device 18 and an illumination device 19 are provided on the front surface of the camera body 11. The flash device 18 irradiates a subject with illumination light in a case where an exposure value of the subject is less than a certain value, or in a forced manner in line with a shutter release in a case where the imaging apparatus 10 is in a still image capturing mode. Meanwhile, the illumination device 19 constantly irradiates the subject with the illumination light in a case where the imaging apparatus 10 is in a video capturing mode.

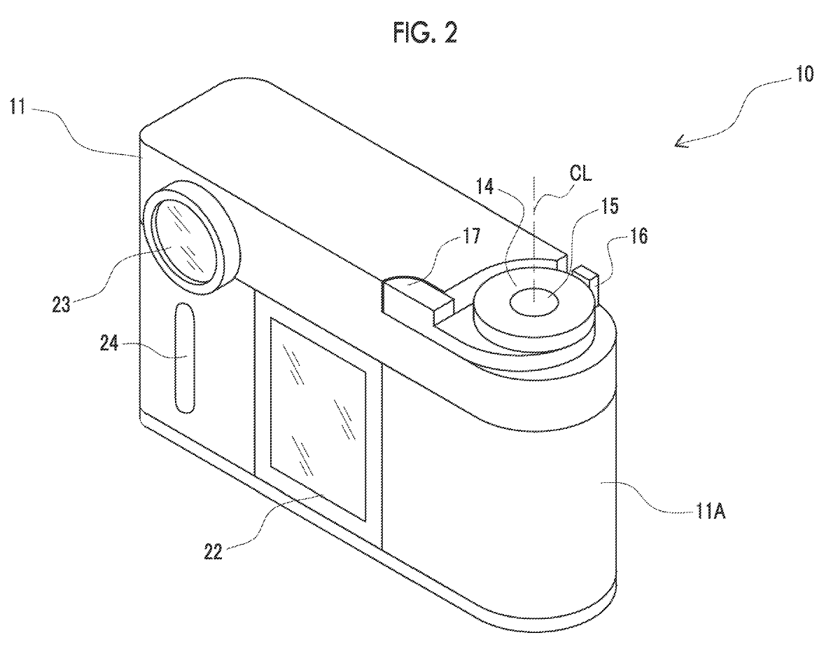

As illustrated in FIG. 2, the lever 17 is provided above the grip 11A. The lever 17 is provided by stacking the mode dial 14 and the release switch 15. The lever 17 is attached to be rotatable about a central axis CL of the mode dial 14. The user can perform a rotation operation on the lever 17, and details of the rotation operation will be described later.

The power switch 16 is a push-type switch and is disposed near the mode dial 14 and the lever 17. A power on/off state of the imaging apparatus 10 is alternately switched in response to pushing of the power switch 16.

The camera body 11 incorporates the imaging element 21 (see FIG. 3). The imaging element 21 is held by a holder (not illustrated) and is fixed to the lens barrel 12 on an image plane side. The imaging element 21 has a still image and video capturing function and is, for example, a complementary metal oxide semiconductor (CMOS) image sensor, a charge coupled device (CCD) image sensor, or an organic thin film imaging element. The imaging element 21 is an imaging element of which a length in a vertical direction is smaller than a length in a horizontal direction in a case where the imaging element is laterally placed, that is, the upper surface of the camera body 11 faces upward in the vertical direction. The imaging element 21 is not limited to this and may be an imaging element of which a length in the vertical direction is larger than a length in the horizontal direction in a case where the imaging element is laterally placed, that is, the upper surface of the camera body 11 faces upward in the vertical direction.

A display 22 (a monitor portion), an electronic view finder 23, and a sub-display 24 are provided on the rear surface of the camera body 11. The display 22 is a liquid crystal display (LCD), an organic electroluminescent display (OELD), or the like and is composed of a touch screen on which the user can perform a touch operation. The display 22 is used for live view display, recorded image display, setting menu display, and the like. In the live view display, a recorded image obtained by imaging the subject via the imaging element 21 is displayed in real time on the display 22.

The sub-display 24 displays information related to quality of the image such as color and is composed of a touch screen on which the user can perform the touch operation, like the display 22.

The electronic view finder 23 is provided in an upper portion of the camera body 11. The electronic view finder 23 displays a live view and displays the recorded image obtained by the imaging the subject via the imaging element 21 in real time. The electronic view finder 23 can be turned on and off, as necessary, and is switched to the display on the display 22.

Hereinafter, the rotation operation of the lever 17 will be described. As illustrated in (A) of FIG. 3, in a case where the power switch 16 is off, a locking mechanism (not illustrated) restricts rotation of the lever 17, and the lever 17 is locked in a posture along the rear surface of the camera body 11. The posture along the rear surface of the camera body 11 means that the lever 17 is at a position at which the lever 17 does not protrude from the rear surface of the camera body 11 in a state seen from above the camera body 11.

As illustrated in (B) of FIG. 3, in a case where the power switch 16 is switched on from off, restriction of the rotation of the lever 17 is released, and the lever 17 is set to a normal position at which the lever 17 is slightly rotated counterclockwise from the rear surface of the camera body 11. The lever 17 is set to a state of the normal position unless the user operates the lever 17. As illustrated in (C) of FIG. 3, a winding operation of performing a rotation operation of the lever 17 in a counterclockwise direction from the normal position can be performed on the lever 17. This rotation operation is used for unlocking a lock on the imaging operation in a film camera mode (unlocking of the lock on the imaging operation will be described later).

Specifically, in the winding operation of the lever 17, the user moves the lever 17 in the counterclockwise direction by hooking a finger on the lever 17, and the lever 17 is rotated. In a case where the finger hooked on the lever 17 is released when the lever 17 is rotated by a certain rotation angle, the lever 17 biased by a spring or the like automatically rotates clockwise and returns to the normal position. Accordingly, the winding operation is completed.

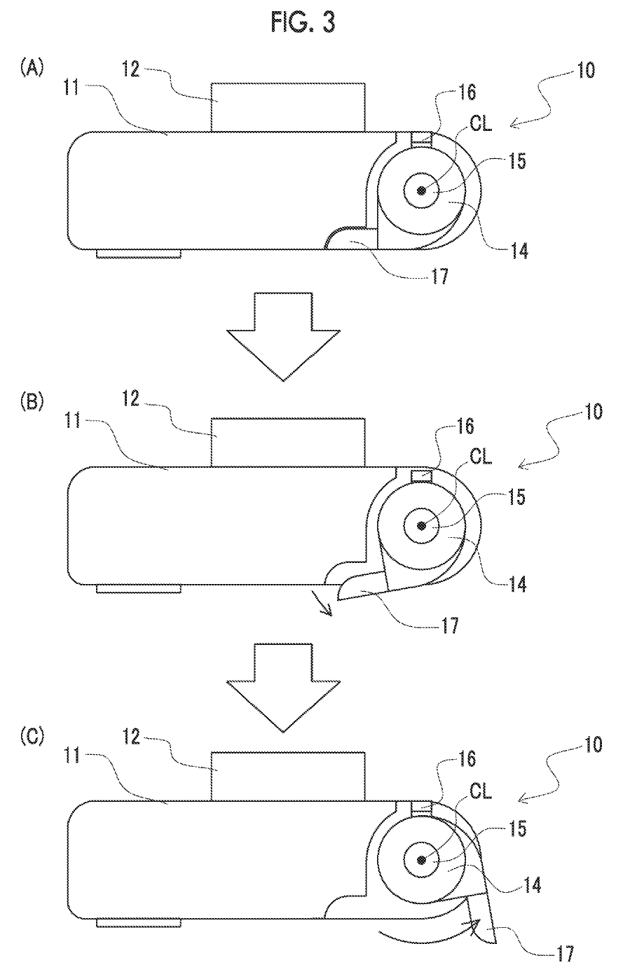

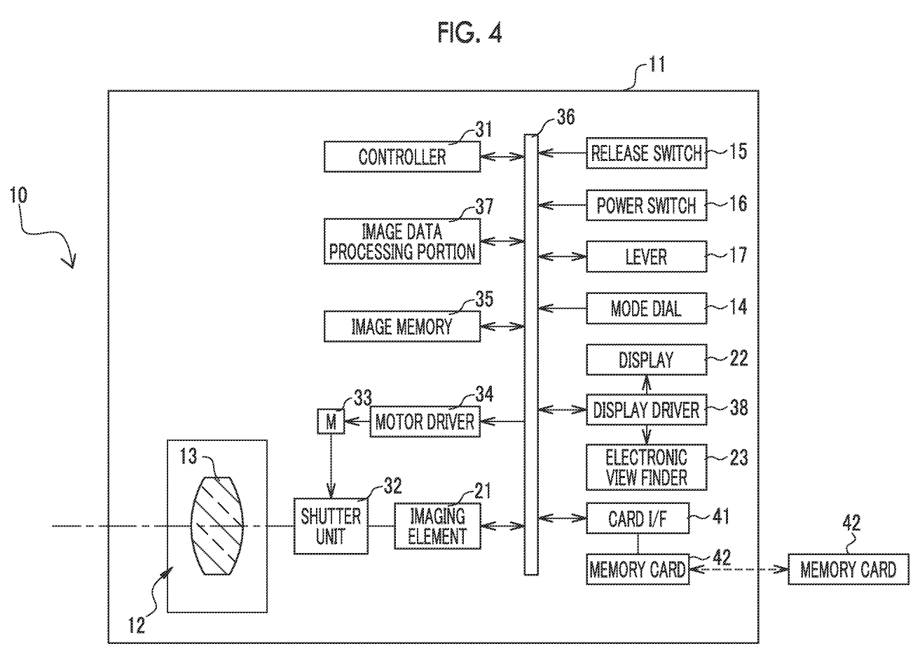

Hereinafter, an electric configuration of the imaging apparatus 10 will be described. As illustrated in FIG. 4, a controller 31 consists of a microcomputer comprising a CPU, a read only memory (ROM) in which a program and a parameter used by the CPU are recorded, a random access memory (RAM) used as a work memory of the CPU, and the like (none illustrated) and functions as a processor that controls each unit of the imaging apparatus 10.

In a case where the rotation operation is performed on the lever 17, a signal for detecting an amount of rotation is transmitted to the controller 31. A mode switching signal from the mode dial 14, a release signal from the release switch 15, and a power on/off signal from the power switch 16 are input into the controller 31.

A shutter unit 32 is, for example, a focal plane shutter and is disposed between the imaging optical system 13 and the imaging element 21. The shutter unit 32 is provided to be capable of shielding an optical path between the imaging optical system 13 and the imaging element 21 and changes between an open state and a closed state. The shutter unit 32 is driven by a shutter motor 33. Driving of the shutter motor 33 is controlled by a motor driver 34.

The shutter unit 32 changes to the open state when live view images and videos are captured. In still image capturing, the shutter unit 32 is changeable to the closed state from the open state in a case where the release switch 15 is not operated, and is changeable to the open state from the closed state in a case where the release switch 15 is operated. The shutter unit 32 operates in the same manner as in video capturing in capturing a preview image in the video capturing mode, and as in the still image capturing in capturing a preview image in the still image capturing mode.

Driving of the imaging element 21 is controlled by the controller 31. The imaging element 21 includes a light-receiving surface composed of a plurality of pixels (not illustrated) arranged in a two-dimensional matrix. Each pixel includes a photoelectric conversion element and generates an imaging signal by photoelectrically converting a subject image formed on the light-receiving surface by the imaging optical system 13.

The imaging element 21 comprises signal processing circuits such as a noise removal circuit, an auto gain controller, and an A/D conversion circuit (none illustrated). The noise removal circuit performs noise removal processing on the imaging signal. The auto gain controller amplifies a level of the imaging signal to an optimal value. The A/D conversion circuit converts the imaging signal into a digital signal and outputs the digital signal to a bus line 36 from the imaging element 21. The output signal of the imaging element 21 is image data (so-called RAW data) including one color signal for each pixel.

An image memory 35 stores the image data of one frame output to the bus line 36. An image data processing portion 37 reads out the image data of one frame from the image memory 35 and performs well-known image processing such as a matrix operation, demosaicing, γ correction, brightness and color difference conversion, and resizing processing.

A display driver 38 sequentially inputs the image data of one frame on which the image processing is performed by the image data processing portion 37, into the display 22 or the electronic view finder 23. For example, the display 22 sequentially displays the live view image in a certain period. The touch operation can be performed on the display 22. By performing the touch operation on an operation icon (not illustrated) or the like displayed on the display 22, an operation and selection corresponding to the operation icon are executed.

A card interface (I/F) 41 is incorporated in a card slot (not illustrated) provided in the camera body 11 and is electrically connected to a memory card 42 inserted into the card slot. The memory card 42 can be inserted into and removed from the card slot by the user. Specifically, the card I/F 41 stores the image data on which the image processing is performed by the image data processing portion 37, in the memory card 42. In reproducing and displaying the image data stored in the memory card 42, the card I/F 41 reads out the image data from the memory card 42. An image recording portion is not limited to a configuration of performing recording on a recording medium such as a memory card and may be a storage device such as a solid state drive (SSD).

The imaging apparatus 10 comprises a plurality of imaging modes such as a normal mode (a second imaging mode) and the film camera mode (a first imaging mode). The normal mode includes the still image capturing mode, the video capturing mode, and the like. The film camera mode is a mode in which image formats are restricted, and is a mode in which an analog feel of a film camera is experienced and reproduced. For switching to the film camera mode from the normal mode, as illustrated in FIG. 5, the display 22 is switched to a screen of the film camera mode illustrated in (B) of FIG. 5 from a screen of the normal mode illustrated in (A) of FIG. 5 by performing the touch operation on the sub-display 24. For switching to the normal mode from the film camera mode, switching to the normal mode from the film camera mode is performed in a case where, for example, a selection is made to finish the film camera mode, or a captured image count reaches a predetermined number in the film camera mode.

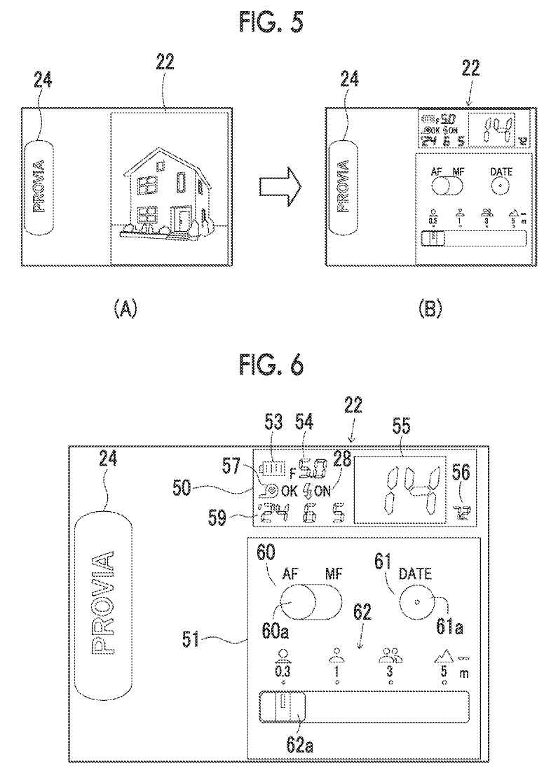

In a case where the film camera mode is selected, the controller 31 outputs user interface information related to the imaging to the display 22, and output of the live view to the display 22 is restricted. Specifically, as illustrated in FIG. 6, a display region of the display 22 displays a touch operation disabled region 50 in which the user cannot perform the touch operation, such as the captured image count as the user interface information related to the imaging, and a touch operation enabled region 51 in which the user can perform the touch operation, such as manual focus. Restriction of the output of the live view to the display 22 includes not displaying the live view image on the display 22 during the film camera mode, unlike in the normal mode. In the film camera mode, it is preferable to restrict and not display videos among the image formats on the display 22.

Here, "PROVIA" displayed on the sub-display 24 is one type of film simulation that is function enabling color development and contrast to be changed as in the case of switching a film of a camera in accordance with what is intended to be imaged. Switching to a type of film simulation (for example, "VELVIA") other than "PROVIA" can be performed by performing the touch operation on the sub-display 24.

The touch operation disabled region 50 displays a remaining battery capacity display portion 53, an F number display portion 54, a captured image count display portion 55, a remaining capture count display portion 56, a lever state display portion 57, a flash presence or absence display portion 58, and a date display portion 59. The remaining battery capacity display portion 53 displays a remaining battery capacity with vertical lines in a shape representing a battery. More vertical lines mean more remaining battery capacity. The F number display portion 54 displays an F number as a numerical value. The captured image count display portion 55 displays the current captured image count. The remaining capture count display portion 56 displays a remaining capture count that is a predetermined captured image count at the start of the film camera mode. For example, the remaining capture count is preferably set to 72, 36, or 24 in accordance with the remaining capture count of the camera film.

The lever state display portion 57 displays whether or not the winding operation of the lever 17 is performed in the film camera mode. Details of the lever state display portion 57 will be described later. The flash presence or absence display portion 58 displays ON in a case where the flash device 18 is turned ON, and displays OFF in a case where the flash device 18 is turned off. The date display portion 59 displays the current date, and the date being displayed is displayed in a superimposed manner on the image in the film camera mode.

The touch operation enabled region 51 displays an AF/MF switching portion 60, a date ON/OFF switching portion 61, and an MF focal length operator 62. In the AF/MF switching portion 60, a round button portion 60a can be slid in the left-to-right direction. In a case where the round button portion 60a is slid to the left side, switching to auto focus (AF) is performed. In a case where the round button portion 60a is slid to a right side, switching to the manual focus (MF) is performed. The MF focal length operator 62 can be operated by switching to the MF.

In the date ON/OFF switching portion 61, a push operation can be performed on a round button portion 61a, and switching between date ON and date OFF can be performed by performing the push operation on the round button portion 61a. In the case of date ON, a center portion of the round button portion 61a is illuminated, and the date being displayed in the date display portion 59 is displayed in a superimposed manner for each imaging. Meanwhile, in the case of date OFF, the center portion of the round button portion 61a is not illuminated. In this case, the date is not displayed in a superimposed manner even in a case where the imaging is performed.

The MF focal length operator 62 includes a slider 62a, and a focal length is set by performing a sliding operation of the slider 62a in the left-to-right direction. In the MF focal length operator 62, the focal length can be set to "0.3 m", "1 m", "3 m", or "5 m". In the case of "0.3 m", a logo representing an example of focusing on near a face of one person is displayed. In the case of "1 m", a logo representing an example of focusing on an upper body of one person is displayed. In the case of "3 m", a logo representing an example of focusing on upper bodies of two persons is displayed. In the case of "5 m", a logo representing an example of focusing on a landscape is displayed. By setting the slider 62a to each position of "0.3 m", "1 m", "3 m", and "5 m", the corresponding focal length can be set.

The controller 31 sets a lock on the imaging operation of the release switch 15 (a first member) in the film camera mode and unlocks the lock based on an operation of the lever 17 (a second member). Meanwhile, in a case where the lock is unlocked, the controller 31 outputs information indicating that the imaging operation of the release switch 15 is valid, as the user interface information. In a case where the imaging operation of the release switch 15 is performed, the controller 31 outputs information related to the captured image count as the user interface information. The controller 31 restricts output of the image data after the imaging to the display 22.

Specifically, as illustrated in (A) of FIG. 7, in a case where switching to the film camera mode from the normal mode is performed, the lever state display portion 57 displays "--" indicating that the winding operation of the lever 17 is not performed. The captured image count display portion 55 displays the current captured image count as "0". In this state, the lock is set on the imaging operation of the release switch 15, and acquisition and storage of a still image in the memory card 42 are not performed even in a case where the release switch 15 is operated.

As illustrated in (B) of FIG. 7, by performing the winding operation of the lever 17, the lever state display portion 57 displays "OK" indicating that the winding operation of the lever 17 is performed. The display of "OK" in the lever state display portion 57 represents information indicating that the imaging operation of the release switch 15 is valid. In this state, the lock on the imaging operation of the release switch 15 is unlocked, and acquisition and storage of the still image in the memory card 42 are performed by operating the release switch 15. In a case where the imaging operation is completed, as illustrated in (C) of FIG. 7, the captured image count display portion 55 changes the display of the current captured image count to "1" from "0", and the lever state display portion 57 is restored to the display of "--" again by resetting the winding operation. When the imaging operation is completed, the display 22 maintains the display of the user interface information (the touch operation disabled region and the touch operation enabled region) of the film camera mode and does not display the image data after the imaging.

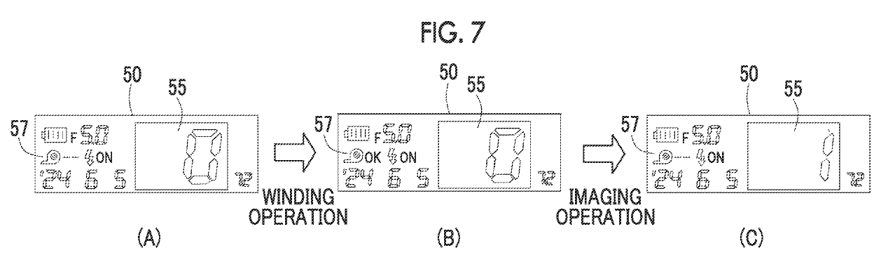

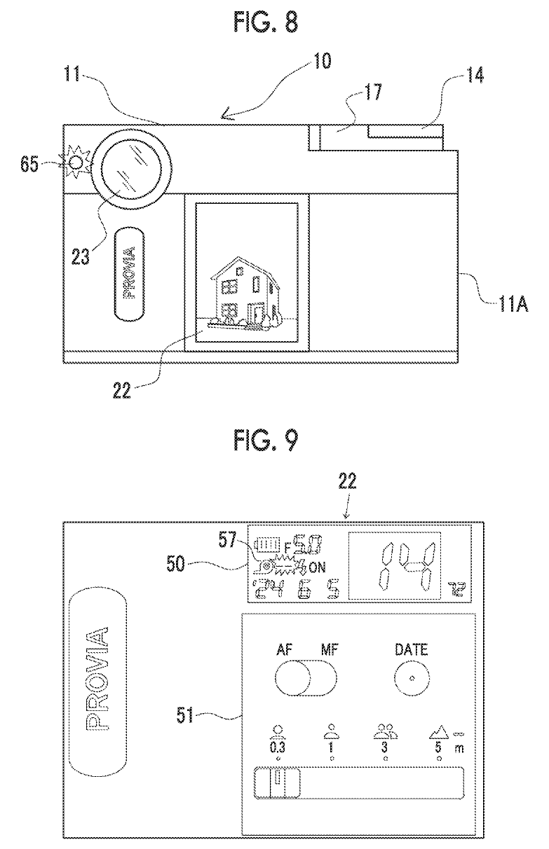

In a case where the imaging operation is performed while the lock is set on the imaging operation, the controller 31 preferably outputs information indicating that the imaging operation is invalid. Specifically, as illustrated in FIG. 8, it is preferable to turn on and off a warning light emitting diode (LED) 65 provided on the left side of the electronic view finder 23, as the information indicating that the imaging operation is invalid. As illustrated in FIG. 9, it is preferable to flash on and off "--" in the lever state display portion 57, as the information indicating that the imaging operation is invalid.

In a case where a selection to finish the film camera mode is made, the controller 31 preferably stores a series of the image data obtained by the imaging in the memory card 42 (a recording medium) as an imaging data group in a single unit format. In a case where the film camera mode is finished, the controller 31 transitions to the normal mode in which the restriction of the output to the display 22 is released.

Specifically, as illustrated in (A) of FIG. 10, in the case of finishing the film camera mode in the middle of the film camera mode, a predetermined touch operation for switching the film camera mode to a finish screen is performed on the sub-display 24. Accordingly, as illustrated in (B) of FIG. 10, a film camera mode finish selection screen 66 is displayed on the display 22. The film camera mode finish selection screen 66 displays a cartridge image 67 representing that the series of the image data obtained by the imaging will be stored in an imaging data group in a single unit format, and a finish selection button 68. The film camera mode is finished by performing the touch operation on the finish selection button 68, and the series of the image data obtained by the imaging are stored in the memory card 42 in a single unit format. Accordingly, as illustrated in (C) of FIG. 10, a transition is made to the normal mode. The non-display of the live view on the display 22 is released, and the live view is displayed on the display 22.

In the film camera mode, in a case where the captured image count reaches the predetermined number, the controller 31 preferably invalidates the imaging operation of the release switch 15 and unlocking of the lock on the imaging operation of the lever 17. In the film camera mode, in a case where the captured image count reaches the predetermined number, the controller 31 preferably stores the series of the image data obtained by the imaging in the memory card 42 as an imaging data group in a single unit format. In a case where the film camera mode is finished, the controller 31 transitions to the normal mode in which the restriction of the output to the display 22 is released. The predetermined number is output to the display 22 as the remaining capture count that is one type of the user interface information.

Specifically, as illustrated in (A) of FIG. 11, in a case where the captured image count reaches "72" that is the remaining capture count, the lever state display portion 57 displays "OFF" indicating that the imaging operation based on the winding operation of the lever 17 is invalid. Accordingly, the imaging operation of the release switch 15 is also invalidated. After a certain amount of time, the display 22 displays a film camera mode finish screen 70, as illustrated in (B) of FIG. 11. The film camera mode finish screen 70 displays the cartridge image 67 representing that the series of the image data obtained by the imaging will be stored in an imaging data group in a single unit format, and a message 71 indicating that the film camera mode is finished. Accordingly, the film camera mode is finished, and the series of the image data obtained by the imaging are stored in the memory card 42 in an imaging data group in a single unit format. By performing a tap operation on the display 22, a transition is made to the normal mode, as illustrated in (C) of FIG. 11. The non-display of the live view on the display 22 is released, and the live view is displayed on the display 22.

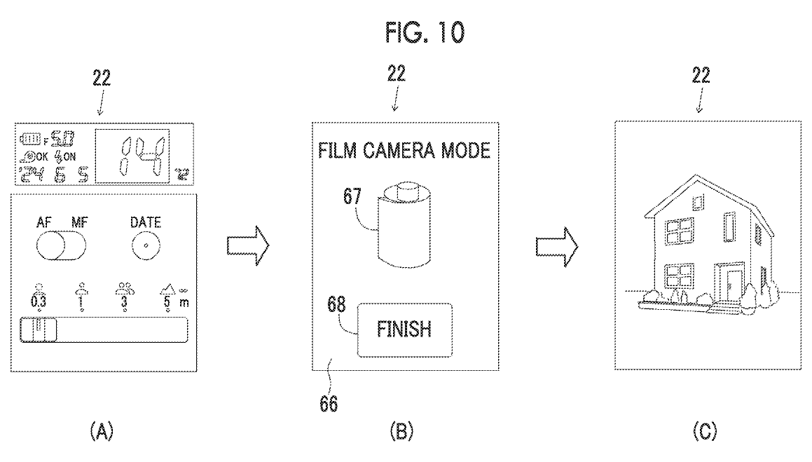

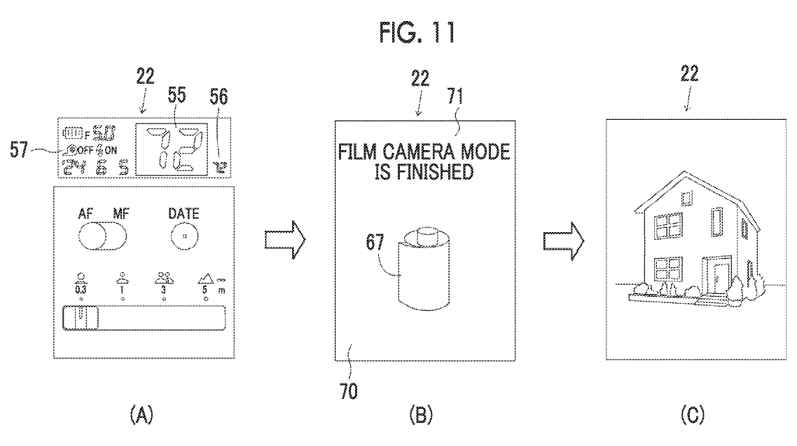

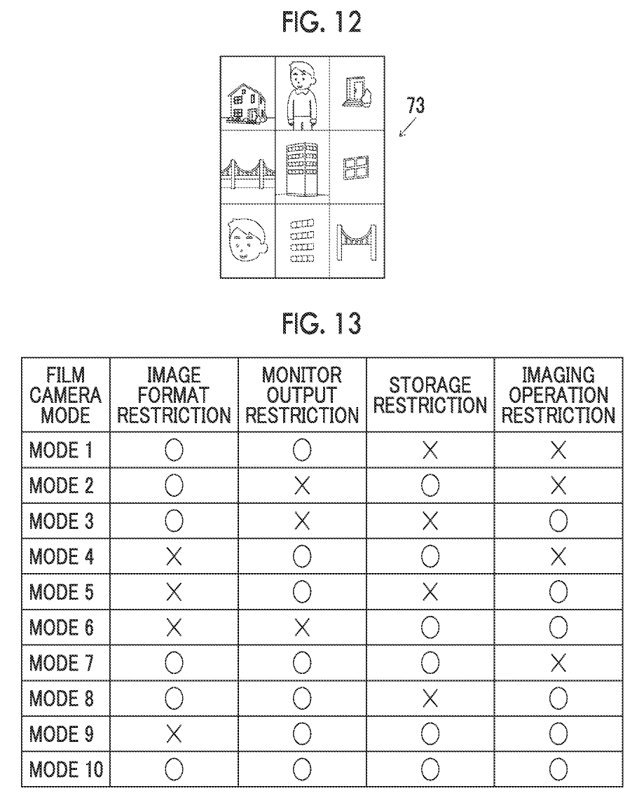

In the film camera mode, the series of the image data obtained by the imaging are preferably stored in the memory card 42 as an imaging data group in a single unit format on which display restriction on the display 22 is imposed. For example, as illustrated in FIG. 12, the series of the image data are stored in the memory card 42 as a thumbnail image group 73 representing each piece of the image data of the captured image count captured so far as a thumbnail. During the film camera mode, since the display restriction on the display 22 is imposed on the thumbnail image group 73, the thumbnail image group 73 is not displayed on the display 22 even in a case where a play button (not illustrated) is operated. Meanwhile, in a case where the film camera mode is finished, the display restriction on the thumbnail image group 73 is released, and the thumbnail image group 73 can be displayed on the display 22.

The film camera mode is preferably a mode in which a digital function of the imaging apparatus 10 is restricted. The controller 31 preferably performs at least two of restriction of the image format, restriction of the output of the live view to the display 22, restriction of the storage of the series of the image data obtained by the imaging in the film camera mode in a format other than the format of a single unit (imaging data group), restriction of the captured image count, and restriction of a second imaging operation following a first imaging operation, as the restriction of the digital function. In the present embodiment, storage in a format other than the format of a single unit (a cartridge image unit) is restricted in the film camera mode. However, in a case where imaging data is captured again in the subsequent film camera mode performed again, the subsequent captured imaging data may be added to the storage data in the format of a single unit obtained in the previous film camera mode.

Specifically, the restriction of the image format preferably allows still images and restricts videos. For the restriction of the output of the live view to the display 22, it is preferable not to display the live view on the display 22. For the restriction of the storage of the series of the image data obtained by the imaging in the film camera mode in a format other than the format of a single unit (imaging data group), it is preferable to prohibit storage in a format other than the thumbnail image group 73. For the restriction of the captured image count, it is preferable to prohibit capturing of the captured image count exceeding the remaining capture count set at the start of the film camera mode. For the restriction of the second imaging operation following the first imaging operation, it is preferable to prohibit consecutive imaging operations of the release switch 15 with respect to the imaging operation of the release switch 15 and, after the first imaging operation is performed, allow the second imaging operation after unlocking the lock on the imaging operation by performing the winding operation of the lever 17.

For the film camera mode, ten patterns of mode 1 to mode 10 can be set as illustrated in FIG. 13. In mode 1 of the film camera mode, two types of restriction including the restriction of the image format (image format restriction) and the restriction of the output of the live view to the display 22 (monitor output restriction) are performed. In mode 2 of the film camera mode, two types of restriction including the image format restriction and the restriction of the storage of the series of the image data obtained by the imaging in the film camera mode in a format other than the format of a single unit (imaging data group) (storage restriction) are performed. In mode 3 of the film camera mode, it is preferable to perform two types of restriction including the image format restriction and the restriction of the second imaging operation following the first imaging operation (imaging operation restriction).

In mode 4 of the film camera mode, it is preferable to perform two types of restriction including the monitor output restriction and the storage restriction. In mode 5 of the film camera mode, it is preferable to perform two types of restriction including the monitor output restriction and the imaging operation restriction. In mode 6 of the film camera mode, it is preferable to perform two types of restriction including the storage restriction and the imaging operation restriction. In mode 7 of the film camera mode, it is preferable to perform three types of restriction including the image format restriction, the monitor output restriction, and the storage restriction. In mode 8 of the film camera mode, it is preferable to perform three types of restriction including the image format restriction, the monitor output restriction, and the imaging operation restriction. In mode 9 of the film camera mode, it is preferable to perform three types of restriction including the monitor output restriction, the storage restriction, and the imaging operation restriction. In mode 10 of the film camera mode, it is preferable to perform four types of restriction including the image format restriction, the monitor output restriction, the storage restriction, and the imaging operation restriction.

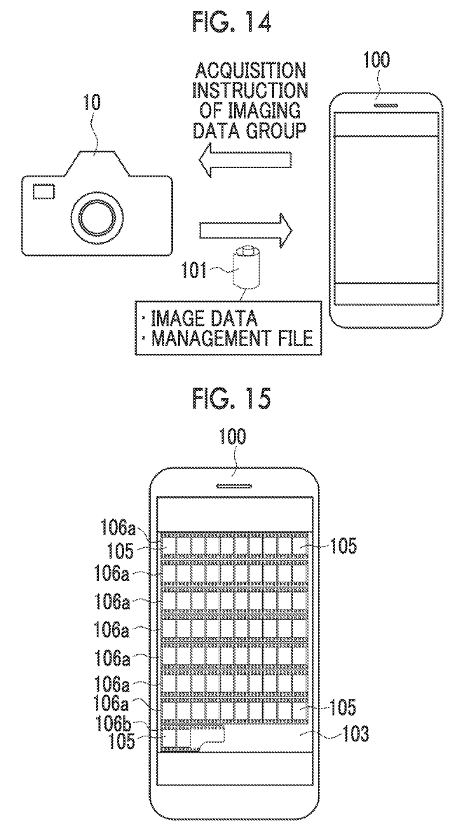

As illustrated in FIG. 14, the image data obtained in the film camera mode in the imaging apparatus 10 is transmitted to an information processing apparatus 100 and can be confirmed as the list image data. The information processing apparatus 100 has a processor (not illustrated) and is, for example, a portable information processing apparatus such as a smartphone, and can be connected to the imaging apparatus 10 in a wired or wireless manner. In the information processing apparatus 100, the processor issues an instruction to acquire the imaging data group obtained in the film camera mode to the imaging apparatus 10. The imaging apparatus 10 transmits an imaging data group 101 captured in the film camera mode to the information processing apparatus 100 in response to the acquisition instruction of the imaging data group. The information processing apparatus 100 acquires the imaging data group 101 transmitted from the imaging apparatus 10. The information processing apparatus 100 may be a PC such as a laptop computer. In addition, the imaging data group 101 includes a management file in which various conditions related to each image data are recorded, in addition to the image data. In addition, the imaging data group may be acquired from a memory card such as an SD card.

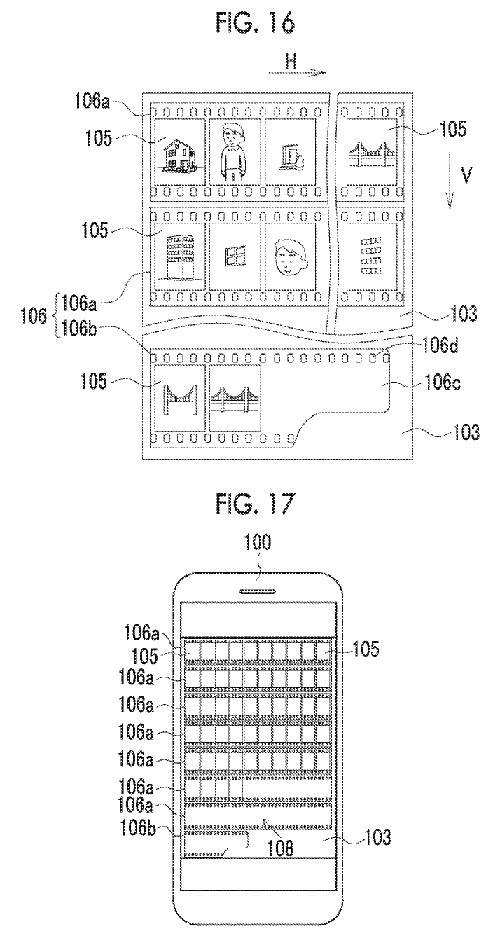

The information processing apparatus 100 generates list image data in which thumbnail images of the image data included in the imaging data group 101 are listed. In the information processing apparatus 100, the generated list image data is set in a template 103 based on the number related to the restriction of the captured image count as illustrated in FIG. 15. In a display 104 of the information processing apparatus 100, thumbnail images 105 are disposed in the template 103 in an order based on the information related to the image data. In FIG. 15, some thumbnail images are denoted by reference numeral 150 (the same applies to FIGS. 16, 17, 18, and 19).

As described above, in the template 103, the list image data is set based on the number related to the restriction of the captured image count in the film camera mode, and the thumbnail images 105 are disposed in an order based on the information related to the image data included in the imaging data group 101. Therefore, it is possible to achieve a sense of unity as the template 103 in which the thumbnail images 105 are disposed, regardless of the captured image count of the image data included in the imaging data group 101.

The number of thumbnail images 105 that can be disposed in the template 103 is determined based on the number related to the restriction of the captured image count. In the present embodiment, since the number related to the restriction of the captured image count is the maximum value of the captured image count, which is 72, the number of the thumbnail images 105 that can be disposed in the template 103 is set to 72. The thumbnail images 105 that can be disposed in the template 103 are disposed to be packed from the end part in order based on the information related to the image data. In the present embodiment, since the order based on the information related to the image data is the imaging order, the thumbnail images 105 are disposed to be packed from the upper end and the left end, which are the end parts, in the template 103 in the imaging order. The end part includes not only the extreme end but also the vicinity thereof.

Specifically, as illustrated in FIG. 16, the template 103 has a plurality of frames 106 in which the thumbnail images 105 are disposed in a lateral direction H (first direction) in a plan view, and each frame 106 is disposed along a vertical direction V (second direction) in a plan view. The frames 106 have a first frame 106a in which the thumbnail images 105 are disposed in accordance with the first number and a second frame 106b in which the thumbnail images 105 are disposed in accordance with the second number smaller than the first number. The template 103 is composed of the first frames 106a disposed in accordance with the third number along the vertical direction V and the second frame 106b disposed at one end along the vertical direction V. The one end includes not only the extreme end but also the vicinity thereof (the same applies hereinafter).

In the present embodiment, in order to dispose 72 thumbnail images 105 in the template 103, the first number, which is the number of thumbnail images 105 disposed in the first frame 106a, is set to 10, the third number, which is the number of first frames 106a disposed in the vertical direction V, is set to 7, and the second number, which is the number of thumbnail images 105 disposed in the second frame 106b, is set to 2 (see FIG. 15). The second frame 106b is disposed at a lower end of the template 103, which is one end along the vertical direction V.

It is preferable that the first frame 106a and the second frame 106b differ in shape. The template 103 represents the film after development, and a right end part 106c of the second frame 106b represents a tab of the end part of the film. In addition, perforation marks 106d (some of which are only denoted by reference numerals) provided at regular intervals at the upper end and the lower end of each of the first frame 106a and the second frame 106b represent the perforation of the film.

In addition, the thumbnail images 105 are disposed to be packed from one end in the first frame 106a and/or the second frame 106b in the imaging order. In the present embodiment, among the 72 thumbnail images 105, the 10 thumbnail images 105 of the 72nd to 63rd are disposed in the first frame 106a at the upper end, packed to the left side in descending imaging order (see FIG. 15). Similarly, the 62nd to 3rd thumbnail images 105 are disposed in the six first frames 106a, ten images in each, packed to the upper side and left side in descending imaging order. The 2nd and 1st thumbnail images 105 are disposed in the second frame 106b at the lower end such that the 2nd thumbnail image 105 is on the left side.

In addition, in a case where a number of thumbnail images less than the number related to the restriction of the captured image count are disposed in the template, the thumbnail images 105 are disposed to be packed from one end in the first frame 106a or the second frame 106b in the order based on the information related to the image data, and a portion other than a portion in which the thumbnail images 105 are disposed in the first frame 106a or the second frame 106b is made blank.

For example, in a case where the number of thumbnail images included in the imaging data group 101 is 54, which is less than the maximum number of captured image count of 72, as illustrated in FIG. 17, in the template 103 in which 72 thumbnail images 105 can be disposed, the 54 thumbnail images 105 are disposed in six first frames 106a, packed to the upper side and left side. The remaining one first frame 106a and the second frame 106b are blank 108.

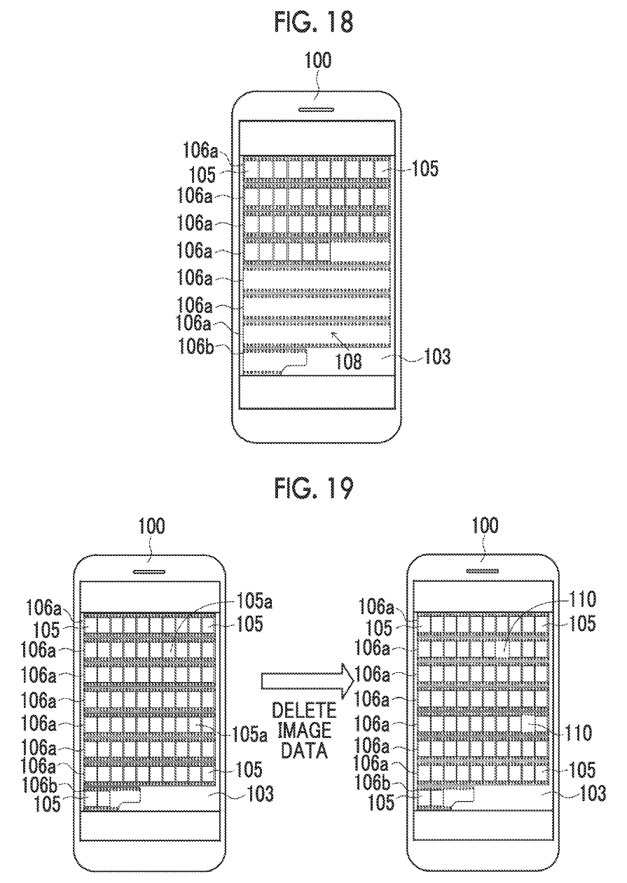

In addition, in a case where the number of thumbnail images included in the imaging data group 101 is 36, which is less than the maximum number of captured image count of 72, as illustrated in FIG. 18, in the template 103 in which 72 thumbnail images 105 can be disposed, 36 thumbnail images 105 are disposed in four first frames 106a, packed to the upper side and left side. The remaining three first frames 106a and the second frame 106b are blank 108.

As described above, even in a case where the captured image count in the film camera mode is less than the maximum number of captured image count, which is 72, such as 54 or 36, the template 103 based on the maximum number of captured image count is used, and the thumbnail images 105 are disposed in the template 103 in the imaging order. Therefore, it is possible to achieve a sense of unity in disposing the thumbnail images 105 regardless of the captured image count. Even in a case of the captured image count in a case where the film camera mode is finished before the predetermined captured image count is reached, the same template 103 is used to dispose the thumbnail images 105 in the same manner. Therefore, even in a case where the captured image count is not the predetermined captured image count, a sense of unity can be achieved.

The information processing apparatus 100 can delete at least one item in the image data included in the imaging data group 101. The deletion of the image data is performed by performing a touch operation on the touch panel display 104. In a case where the image data is deleted, the update processing of the list image data is performed. In this case, the information processing apparatus 100 makes a portion in which the deleted image data has been disposed in the list image data blank. For example, as illustrated in FIG. 19, in a case where the image data corresponding to a thumbnail image 105a is deleted as the image data to be deleted in the template 103 before the deletion of the image data, in the template 103 after the deletion of the image data, a portion in which the deleted image data has been disposed is blank 110.

In addition to a case where the image data is deleted, even in a case where at least one item in the image data loses the relevance to the imaging in the film camera mode, a portion in which the image data whose relevance to the imaging in the film camera mode has been lost is disposed may be made blank. Examples of the case where the relevance to the imaging in the film camera mode is lost include a case where the image data is moved from the directory in which the imaging data group 101 is stored to another directory. In this case, the image data moved to the other directory is not limited to the display in the template 103, and can be displayed in units of one sheet.

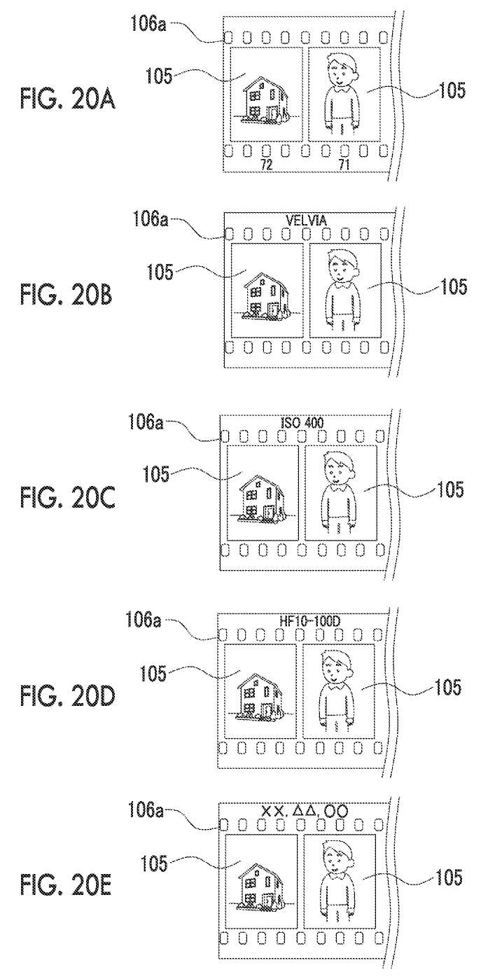

The information processing apparatus 100 superimposes an imaging condition set in the film camera mode on the list image data. Accordingly, the imaging conditions are displayed in a superimposed manner in the template 103. The imaging condition is data associated with a management file (see FIG. 14) included in the imaging data group 101. For example, as illustrated in FIG. 20A, as the imaging condition, a photo number (in FIG. 20A, “72” and “71”) indicating imaging order is superimposed and displayed for each thumbnail image 105. In addition, as illustrated in FIG. 20B, as the imaging condition, the type (VELVIA) of the film simulation selected in a case where the film camera mode is started is displayed in a superimposed manner. Further, as illustrated in FIG. 20C, a sensitivity (ISO 400) set by the user is superimposed and displayed as the imaging condition. In addition, as illustrated in FIG. 20D, the unique ID (HF10-100D) of the imaging apparatus 10 in which the film camera mode is executed is displayed in a superimposed manner as the imaging condition. In addition, as illustrated in FIG. 20E, as the imaging condition, the date in a case where the date ON/OFF switching portion 61 of the imaging apparatus 10 is turned ON is displayed in a superimposed manner.

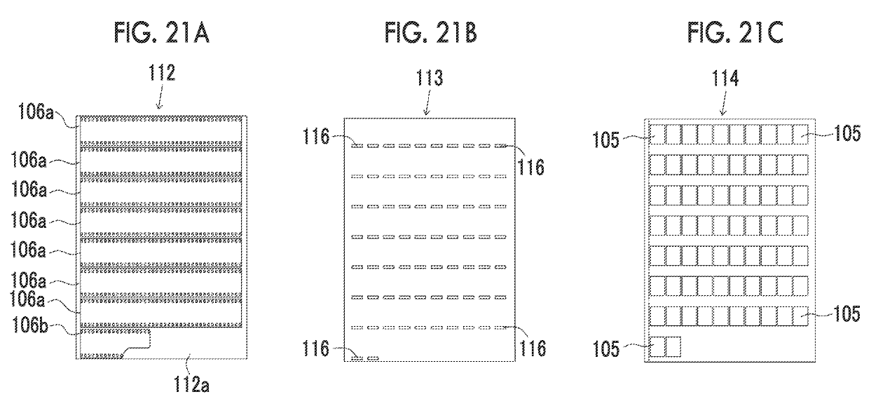

In the information processing apparatus 100, the color, the format, and the like of the template 103 can be changed. Therefore, the list image data for generating the template 103 consists of a first layer 112 which is a layer of the background data as illustrated in FIG. 21A, a second layer 113 which is a layer of the data related to the imaging condition as illustrated in FIG. 21B, and a third layer 114 which is a layer of the image data as illustrated in FIG. 21C. In the first layer 112, the first frame 106a and the second frame 106b are provided on a background image 112a of a predetermined color. The color of the background image 112a can be changed in the layout setting menu of the information processing apparatus 100 (for example, black, white, and the like). The shapes and the like of the first frame 106a and the second frame 106b can also be changed in the layout setting menu of the information processing apparatus 100 within a range in which the shape and the like of the film can be reproduced. In the template 103, in addition to the case where the first layer 112, the second layer 113, and the third layer 114 are stacked in this order, the layers may be stacked in another order.

In the second layer 113, the data related to the imaging condition is also changed by changing the management file each time the imaging data group 101 is acquired. Data related to the imaging condition is displayed in the second layer 113 by characters 116 (some of which are only denoted with reference numerals). The image data of the third layer 114 is changed each time the imaging data group 101 is acquired. In addition, in the third layer 114, in a case where the specific image data in the image data is deleted or the specific image data is moved to a directory different from the storage directory of the imaging data group 101, for example, the image data of the third layer 114 is changed according to the deletion or the movement.

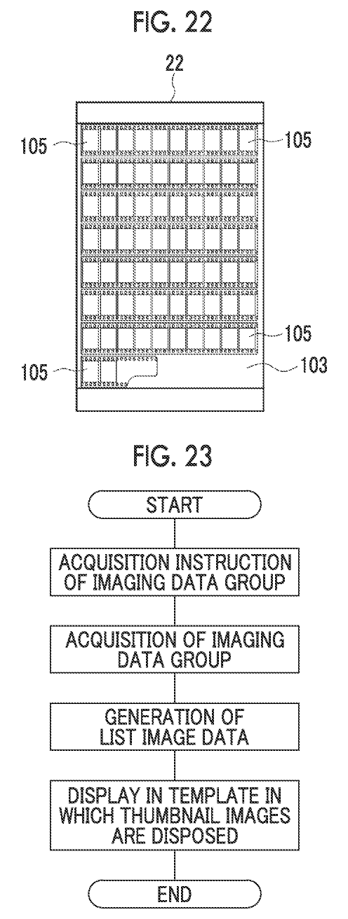

The imaging apparatus 10 may be used as the information processing apparatus 100. In this case, the imaging apparatus 10 also has a function of generating the list image data based on the imaging data group captured in the film camera mode. After the finishing of the film camera mode, the imaging apparatus 10 selects the display of the list image to display the template 103 set based on the list image data on the display 22 as illustrated in FIG. 22. The template 103 displayed on the display 22 represents the film, and is different from the thumbnail image group 73 (see FIG. 12) displayed on the same display 22.

Next, an information processing method according to the embodiment of the present invention will be described with reference to the flowchart in FIG. 23. In the information processing apparatus 100, the processor issues an instruction to acquire the imaging data group obtained in the film camera mode to the imaging apparatus 10. The imaging apparatus 10 transmits an imaging data group 101 captured in the film camera mode to the information processing apparatus 100 in response to the acquisition instruction of the imaging data group. The information processing apparatus 100 acquires the imaging data group 101 transmitted from the imaging apparatus 10.

The information processing apparatus 100 generates list image data in which thumbnail images of the image data included in the imaging data group 101 are listed. The list image data is set in the template 103 based on the number related to the restriction of the captured image count. The template 103 is displayed on the display 104 of the information processing apparatus 100. The thumbnail images 105 are disposed in the template 103 in an order based on the information related to the image data.

An information processing program according to the embodiment of the present invention is stored in a program memory (not illustrated) of the information processing apparatus 100. An information processing program according to the embodiment of the present invention causes a processor of the information processing apparatus 100 to execute a function of acquiring the imaging data group 101 imaged in the film camera mode, and a function of generating list image data in which thumbnail images of image data included in the imaging data group are listed, in which the list image data is set in a template based on a number related to the restriction of the captured image count, and the thumbnail images are disposed in the template in an order based on information related to the image data.

In the present embodiment, each processing is executed by any computer. Any computer may execute those processing via a processor, a program, or a combination thereof. Any computer may be a general-purpose computer, a computer for a specific purpose, a system such as a workstation, or other hardware elements capable of executing a program.

The processor may be composed of one or a plurality of pieces of hardware, and types of hardware are not limited. For example, the processor may be composed of hardware such as a central processing unit (CPU), a micro processing unit (MPU), a programmable logic device such as a field programmable gate array (FPGA), a dedicated circuit for executing specific processing, such as an application specific integrated circuit (ASIC), a graphic processing unit (GPU), or a neural processing unit (NPU). The processor includes each unit or each means that executes various types of processing in the present embodiment. Types of hardware may be a combination of different types of hardware. In a case where a plurality of pieces of hardware are configured to execute one or a plurality of types of processing of a processor, the plurality of pieces of hardware may be present in apparatuses physically separated from each other or may be present in the same apparatus. In any embodiment, the order of each processing via the processor is not limited to the above order and may be appropriately changed. The hardware is composed of an electric circuit (circuitry) in which circuit elements such as semiconductor elements are combined.

The present embodiment may be implemented by hardware, software, firmware, microcode, or a combination thereof. Software, firmware, and microcode are composed of a program. For example, the program may be a program module group, and each function thereof may be implemented by a processor configured to execute each function. The program may be a program code or a plurality of code segments stored in one or a plurality of non-transitory computer-readable media (for example, recording media or other storages). The program may be divided and stored in a plurality of non-transitory computer-readable media present in apparatuses physically separated from each other. The program code or the code segments may represent any combination of a procedure, a function, a subprogram, a routine, a subroutine, a module, a software package, a class, an instruction, a data structure, and a program statement. The program code or the code segments may be connected to other code segments or hardware circuits by transmitting and receiving information, data, an argument, a parameter, or content of a memory.

While each embodiment illustrates the digital camera in which the imaging optical system 13 is fixed to the camera body 11, the present invention is not limited to this, and a lens-interchangeable digital camera in which an imaging optical system is interchangeable with respect to a camera body may be applied. While each embodiment illustrates the lens barrel 12 not including a zoom lens, the present invention is not limited to this, and the imaging optical system 13 may be configured to include a zoom lens. The present invention can be applied to a smartphone and a camera such as a video camera, other than the digital camera.

### Explanation of References

10: imaging apparatus

11: camera body

11A: grip

12: lens barrel

13: imaging optical system

14: mode dial

15: release switch

16: power switch

17: lever

18: flash device

19: illumination device

21: imaging element

22: display

23: electronic view finder

24: sub-display

31: controller

32: shutter unit

33: shutter motor

34: motor driver

35: image memory

36: bus line

37: image data processing portion

38: display driver

41: card interface (I/F)

42: memory card

50: touch operation disabled region

51: touch operation enabled region

53: remaining battery capacity display portion

54: F number display portion

55: captured image count display portion

56: remaining capture count display portion

57: lever state display portion

58: flash presence or absence display portion

59: date display portion

60: AF/MF switching portion

60a: round button portion

61: date ON/OFF switching portion

61a: round button portion

62: MF focal length operator

62a: slider

65: warning LED

66: film camera mode finish selection screen

67: cartridge image

68: finish selection button

70: film camera mode finish screen

71: message

73: thumbnail image group

100: information processing apparatus

101: imaging data group

103: template

104: display

105: thumbnail image

106: frame

106a: first frame

106b: second frame

106c: right end part

106d: perforation mark

108: blank

110: blank 112 first layer

113: second layer 114: third layer

116: character

CL: central axis

H: lateral direction

OA: optical axis

V: vertical direction

What is claimed is:

1. An information processing apparatus comprising a processor,
wherein the processor is configured to:
acquire an imaging data group imaged in a first imaging mode in which a captured image count is restricted; and
generate list image data in which thumbnail images of image data included in the imaging data group are listed,
the list image data is defined by a template based on a number related to the restriction of the captured image count, and
the thumbnail images are arranged in the template in an order based on information related to the image data.

2. The information processing apparatus according to claim 1,
wherein the number of the thumbnail images that can be arranged in the template is determined based on the number related to the restriction of the captured image count, and
the thumbnail images to be arranged in the template are arranged starting at one end in the order based on the information related to the image data.

3. The information processing apparatus according to claim 1,
wherein the template includes a plurality of frames in which the thumbnail images are arranged in a first direction, and each of the frames is disposed in a second direction.

4. The information processing apparatus according to claim 3,
wherein the thumbnail images are arranged starting at one end in the frame in the order based on the information related to the image data.

5. The information processing apparatus according to claim 3,
wherein the frames include a first frame that accommodates a first number of the thumbnail images and a second frame that accommodates a second number of the thumbnail images , the second number being smaller than the first number, and
the template includes a third number of the first frames arranged in the second direction and the second frame disposed at one end in the second direction.

6. The information processing apparatus according to claim 5,
wherein the first frame and the second frame differ in shape.

7. The information processing apparatus according to claim 5,
wherein the thumbnail images are arranged starting at one end in the first frame and/or the second frame in the order based on the information related to the image data.

8. The information processing apparatus according to claim 5,
wherein, in a case where a number of thumbnail images less than the number related to the restriction of the captured image count are arranged in the template,
the thumbnail images are arranged starting at one end in the first frame or the second frame in the order based on the information related to the image data, and
a portion other than a portion in which the thumbnail images are disposed in the first frame or the second frame is made blank.

9. The information processing apparatus according to claim 1,
wherein, in a case where at least one item in the image data is deleted,
the processor makes a portion of the list image data where the deleted image data has been disposed blank.

10. The information processing apparatus according to claim 1,
wherein, in a case where at least one item in the image data loses relevance to the imaging in the first imaging mode,
the processor makes a portion of the list image data where the image data that has lost the relevance is disposed blank.

11. The information processing apparatus according to claim 1,
wherein the processor is configured to superimpose an imaging condition set in the first imaging mode on the list image data.

12. The information processing apparatus according to claim 11,
wherein the imaging condition is data associated with a management file included in the imaging data group.

13. The information processing apparatus according to claim 11,
wherein the processor is configured to superimpose the imaging condition on each of the thumbnail images.

14. The information processing apparatus according to claim 11,
wherein the list image data consists of
a first layer which is a layer of background data,
a second layer which is a layer of data related to the imaging condition, and
a third layer which is a layer of the image data.

15. The information processing apparatus according to claim 1, wherein, in the first imaging mode, in addition to the restriction of the captured image count, at least two of the followings are performed: (i) a restriction of image formats, (ii) a restriction of output of a live view, (iii) a restriction of storage of a series of image data obtained by the imaging in the first imaging mode in a format other than a single unit format, and (iv) a restriction of a second imaging operation following a first imaging operation.

16. The information processing apparatus according to claim 1,
wherein the number related to the restriction of the captured image count is a maximum number of the captured image count.

17. The information processing apparatus according to claim 1,
wherein the order based on the information related to the image data is an imaging order.

18. An imaging apparatus, which is used as the information processing apparatus according to claim 1.

19. An information processing method comprising:
via a processor of an information processing apparatus,
acquiring an imaging data group imaged in a first imaging mode in which a captured image count is restricted; and
generating list image data in which thumbnail images of image data included in the imaging data group are listed,
wherein the list image data is defined by a template based on a number related to the restriction of the captured image count, and
the thumbnail images are arranged in the template in an order based on information related to the image data.

20. A non-transitory computer readable medium for storing an information processing program, wherein the information processing program causes a processor of an information processing apparatus to execute:
a function of acquiring an imaging data group imaged in a first imaging mode in which a captured image count is restricted; and
a function of generating list image data in which thumbnail images of image data included in the imaging data group are listed,
wherein the list image data is defined by a template based on a number related to the restriction of the captured image count, and
the thumbnail images are arranged in the template in an order based on information related to the image data.
